(19) United States
(12) Patent Application Publication
(10) Pub. No.: US 2009/0114297 A1
(43) Pub. Date: May 7, 2009

(54) RESIDENTIAL FIRE SERVICE FIXTURE

(76) Inventors: Floyd Stanley Salser, Ocala, FL (US); Michael J. Kebles, Las Vegas, NV (US)

Correspondence Address: SIMMONS PATENTS, P.O. BOX 1560, LENOIR, NC, 28645, US

(21) Appl. No.: 12/263,606

(22) Filed: Nov. 3, 2008

Related U.S. Application Data
(60) Provisional application No. 60/984,782, filed on Nov. 2, 2007.

(51) Int. Cl. F16K 11/00

(52) U.S. Cl. 137/625.11

(57) ABSTRACT

The invention relates to an apparatus and method for providing a plurality of metered service lines to a residential utility system wherein one of the service lines may be independently disabled without affecting the other service lines. For a water utility, the apparatus includes a fixture comprising one input and a plurality of outputs wherein at least one output is configured with a shutoff valve. Be figured is suitably sized to fit inside a standard utility meter box. Alternatively, a standard prior art meter is configured with one input and a plurality of outputs wherein at least one output is configured with a shutoff valve so that they flowed through such outputs may be independently controlled. Additionally, a prior art utility meter box may be configured when one input fixture and an output fixture comprising a plurality of outputs wherein at least one output is configured with the shutoff valve.

This application claims priority to provisional application 60/984,782 filed on Nov. 2, 2007 which is incorporated herein by this reference for all that it discloses.

### TECHNICAL FIELD OF THE INVENTION

The present invention relates to an apparatus and method for allowing a utility provider to interrupt water service to a first residential service line while not interrupting such utility service to a second residential service line associated with such utility service where both first and second residential service lines are metered to monitor resource consumption.

### BACKGROUND

Utility companies are increasingly finding a need to provide two or more service lines for residential installations. One application in particular where a dual service line is needed in a residential environment relates to fire sprinkler systems. The world's first sprinkler system was installed in the United Kingdom in 1812. Sprinklers have been used in the United States since 1874 and such systems are required by many building codes. In addition, such sprinkler systems are becoming increasingly popular in residential applications. Insurance companies frequently offer reduced rates for residential homes equipped with fire suppression systems such as a sprinkler system.

There are many types of fire suppression systems including wet pipe systems, dry pipe systems, deluge systems, pre-action systems, and calm water sprinkler systems. Wet pipe systems are by far the most popular systems used in the residential environment. Such systems require at least two service lines to be provided from the utility meter to the residents. One service line provides the typical water supply to a residence while the second service line provides water to the fire sprinkler system.

A big problem with such prior art systems relates to the fire service line not being metered. Such is necessary in prior art systems because the water utility may wish to turn off the residential water supply without disabling the fire suppression system. Therefore, the supply line supplying water to the fire line service was necessarily connected to a point in front of the main water service shutoff valve. Unfortunately, in prior art systems, such shutoff valve is located at the input of the meter metering water consumption. There has been a long felt need for an apparatus that provides a plurality of metered service lines where one service line may be disabled while not disabling a second service line. The present invention addresses such need.

### SUMMARY

Objects and advantages of the invention will be set forth in the following description, or may be obvious from the description, or may be learned through practice of the invention.

Broadly speaking, a principal object of the present invention is to provide a residential utility service requiring a plurality of service lines with a plurality of metered utility service lines wherein such plurality of service lines may be independently enabled or disabled.

Another general object of the present invention is to provide an utility meter housing configured with at least one input suitable for associating a utility service line with a utility meter, and an output fixture comprising a fixture input and a plurality of fixture outputs wherein the fixture input is suitable for being associated with the output of a water meter and the fixture outputs are suitable for being associated with the service lines supplying a resource to a residence.

Yet another general object of the present invention is to provide a utility meter comprising an input and a plurality of outputs, wherein one output is configured with a shutoff valve.

Another general object of the invention is to provide fixture comprising one in and a plurality of outputs where the flow through such outputs may be independently interrupted or enabled.

Additional embodiments of the present subject matter, not necessarily expressed in this summarized section, may include and incorporate various combinations of aspects of features or parts referenced in the summarized objectives above, and/or features or components as otherwise discussed in this application.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is an elevated perspective do you owe one exemplary embodiment of the invention comprising a utility box configured with an output fixture;

FIG. 2 is an side elevated perspective view of one exemplary embodiment of the invention comprising a utility meter with a fluid chamber comprising one input and a plurality of outputs;

FIG. 3 is an elevated perspective view of a flow control fixture according to one exemplary embodiment of the invention;

FIG. 4 is a front side view of the flow control fixture depicted in FIG. 3;

FIG. 5 is a backside view of the flow control fixture depicted in FIG. 3; and

FIG. 6 is a top view of the flow control fixture depicted in FIG. 3.

Repeat use of reference characters throughout the present specification and appended drawings is intended to represent the same or analogous features or elements of the present technology.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements or steps. It is to be understood by one of ordinary skill in the art that the present discussion is a description of exemplary embodiments only, and is not intended as limiting the broader aspects of the present invention.

It should be appreciated that this document contains headings. Such headings are simply place markers used for ease of reference to assist a reader and do not form part of this document or affect its construction.

For the purposes of this document two or more items are “mechanically associated” by bringing them together or into relationship with each other in any number of ways including a direct or indirect physical connection that may be releasable (snaps, rivets, screws, bolts, etc.) and/or movable (rotating, pivoting, oscillating, etc.)

Similarly, for the purposes of this document, two items are “electrically associated” by bringing them together or into relationship with each other in any number of ways. For example, methods of electrically associating two electronic items/components include: (a) a direct, indirect or inductive communication connection, and (b) a direct/indirect or inductive power connection. Additionally, while the drawings illustrate various components of the system connected by a single line, it will be appreciated that such lines represent one or more connections or cables as required for the embodiment of interest.

While the particulars of the present invention may be adapted for use in any process for conditioning materials, the examples discussed herein are primarily in the context conditioning plastic to be used in a recycling process.

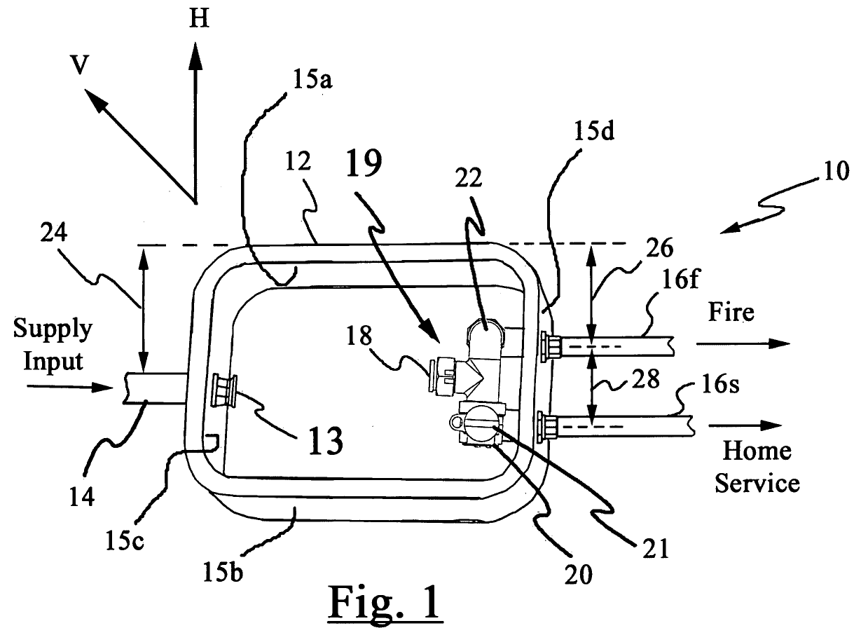

Referring now to FIG. 1, a residential utility meter enclosure (10) according to certain embodiments of the presently preferred invention is presented. Enclosure (10) is configured for receiving a typical residential utility meter configured for metering resource consumption, wherein the utility meter comprises one input and one output. Enclosure (10) defines a rectangular shape comprising two sets of opposed walls in one integral piece. It should be appreciated that enclosures defining any suitable shape and enclosures comprised of the plurality of components connected together to form such shape fall within the scope of the present invention. For the presently preferred embodiment enclosure 10 comprises a first wall 15c opposed by a second wall 15d wherein the first wall 15c defines a service input 13 and wherein the second wall 15d defines an plurality of enclosure outputs associated with residential service line (16f) and residential service line (16s).

Enclosure 10 further comprises an output-fixture (19) defining a fixture-input (18), a first enclosure output and a second enclosure output. The first enclosure output is associated with residential service line 16s, and a second enclosure output is associated with residential service line 16f. Fixture-input (18) is preferably configured for being associated with the output of a typical residential utility meter. The first enclosure output and the second enclosure output are preferably associated with an output nut that is adjustable for different types of connections such as flared copper connections, compression connections, and iron pipe feting.

As shown FIG. 1, one end of service input 13 is associated with a utility service supply line 14 and the opposing end is configured for being associated with the input of a utility meter. For this embodiment of the invention, service input 13 is in substantial horizontal alignment (direction “V” as indicated in FIG. 1) with said fixture-input 18. Additionally, for the embodiment depicted in FIG. 1 service input 13 is in vertical alignment with fixture-input 18. Other configurations where the service input 13 is not insubstantial online and with the fixture-input 18 fall within the scope of the present invention.

Still referring to FIG. 1, the first enclosure output is associated with a flow control valve 21. For the presently preferred embodiment, flow control valve 21 is an angle ball out although any suitable valve technology may be used. Flow control valve 21 is configured to control the flow of resources through said first fixture output without affecting the flow of resource through said second fixture output. One of ordinary skill in the art will appreciate that such a configuration allows the flow through the first fixture output to be disabled while still allowing flow through the second fixture output.

For one alternative embodiment, the second output 22 is configured with a flow control valve. Such a configuration allows the flow of resources to either fixed or output to be interrupted independent of one another. Such a configuration is particularly useful for installations where only one output is presently needed but a need for a second output is anticipated in the future. Consequently, it should be appreciated that a residential utility meter enclosure are according to embodiments of the present invention include configurations that have three or more outputs and a number of control valve configurations.

For the preferred embodiment of the residential utility meter enclosure 10, the metal components are composed of lead free waterworks brass or an engineered polymer resin or other suitable plastic material.

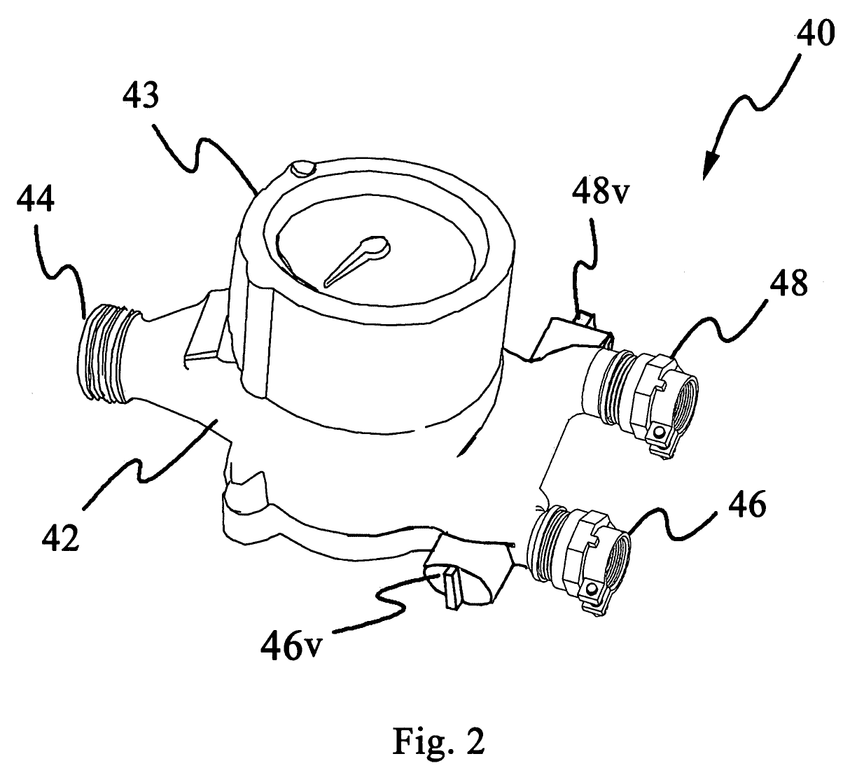

Referring now to FIG. 2, a residential utility meter (40) incorporating certain aspects of the present invention is now considered. Residential utility meter (40) comprises a fluid chamber (42) and a register (43) configured for metering the flow of water through a water system. For the presently preferred embodiment of the invention, fluid chamber (42) defines a flow detection section disposed between an input (44) and a plurality of outputs, said plurality of outputs comprising a first output (46) and second output (48). Fluid chamber 42 is configured so that water flows into said input (44), through said flow detection section and then to said first output and said second output.

A first cutoff valve (46v) is disposed between the first output (46) and said flow detection section. First cutoff valve (46) is configured with a first state that allows the flow of water through the first output and a second state which prevents the flow of water through the first output. Similarly, a second cutoff valve (48v) is disposed between the second output (48) and said flow detection section and is configured with a first state that allows the flow of water through the second output (48) and a second state which prevents the flow of water through the second output (48). First cut off valve 46v the and second cutoff valve 48v are configured so that the water flow through the second output (48) is not dependent on the state of the first cutoff valve (46v) and the water flow through the first output (46) is not dependent on the state of the second cutoff valve (48v). One of ordinary skill in the art will appreciate that such a configuration allows resource flow through output 46 to be independent of the resource flow through output 48. Additionally, utility meter 40 may be used for meter installations currently requiring only one residential service line but an additional service line may be required in the future.

For the presently preferred embodiment, the first cutoff valve (46v) and the second cutoff valve (48v) are in horizontal alignment and vertical alignment with each other. Similarly, first output (46), and second output (48) are in alignment with each other. Additionally, the first cutoff valve (46v) is disposed adjacent to first output (46) and the second cutoff valve is disposed adjacent to second output (48). Such an embodiment for utility meter 40 allows the meter to be installed in a standard residential utility meter box having a single input and a dual output.

As described above for the residential utility meter box 10, the first cutoff valve and said second cutoff valve are angle ball valves comprising a lockable valve key (not depicted in FIG. 2). Similarly they fluid chamber components are constructed from water works brass, an engineered polymer resin, or some other plastic material.

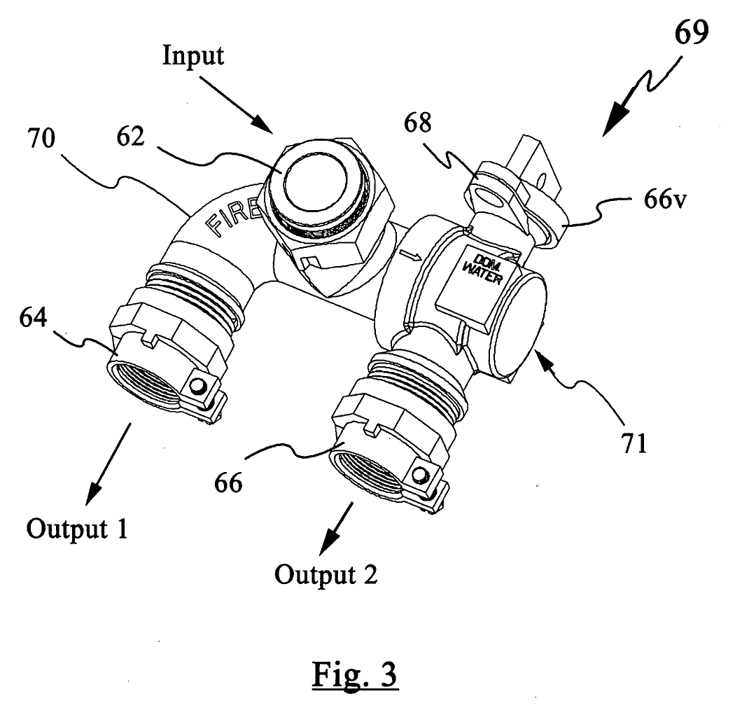

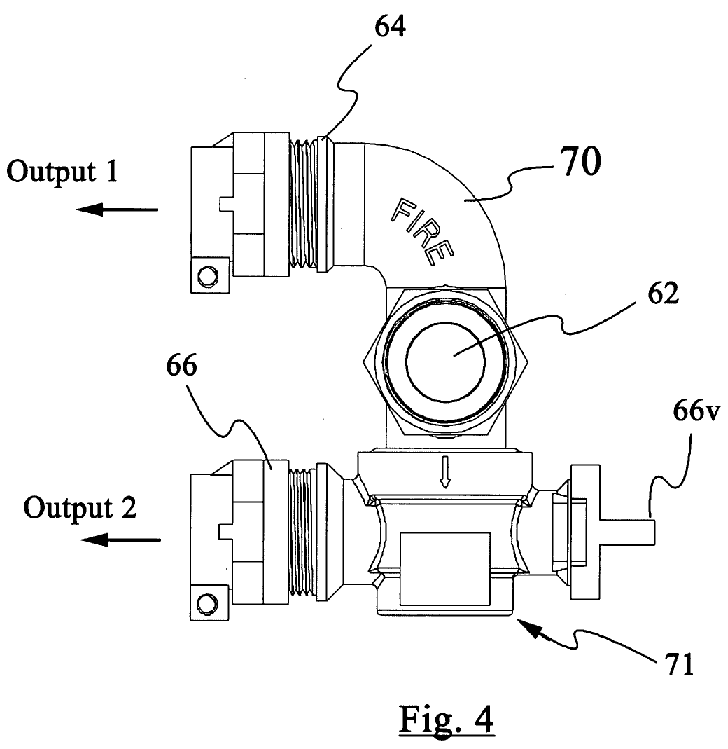

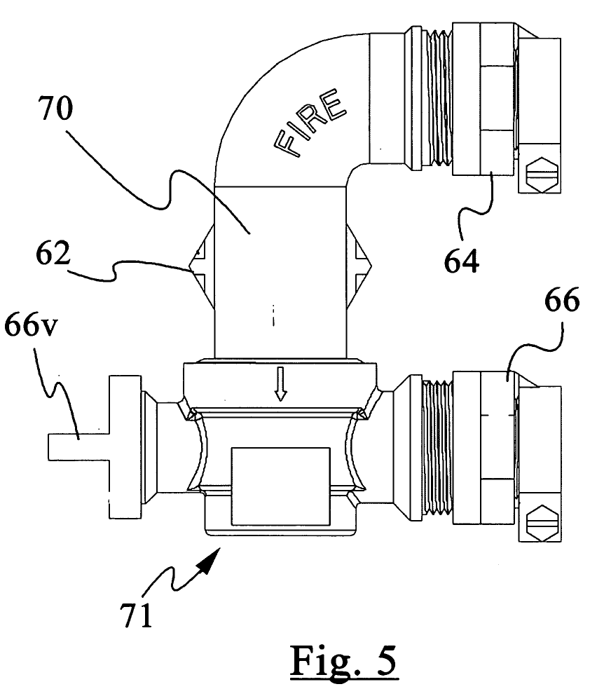

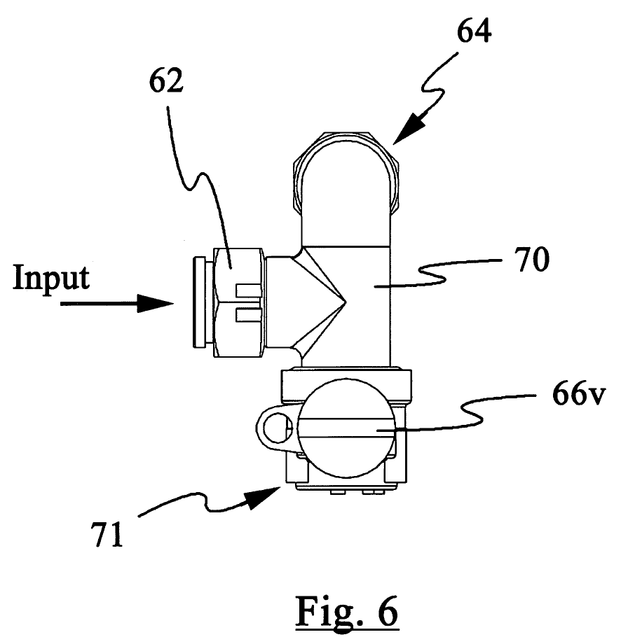

Referring now to FIG. 3, FIG. 4, FIG. 5, and FIG. 6, a flow control fixture 69 according to various aspects of the present invention is considered. Flow control fixture 69 is configured for being disposed between the output of a utility meter and the output of a utility meter box to control the flow there between. Flow control fixture 69 comprises a fixture input 62 suitably configured for being associated with the output of a utility meter. Fixture input 62 is connected with a polarity of fixture outputs through a fixture body 70. For the presently preferred embodiment, flow control fixture 69 comprises two outputs; fixture output 64 and fixture output 66. Fixture outputs 64 and 66 are suitably configured for being associated with the resource supply lines of a residential supply system for a resource such as water. Fixture body 70 is disposed between fixture input 62 and the fixture outputs and is suitably configured for directing the flow of resource from said fixture input to the fixture outputs 64 and 66.

A first flow control valve 66v is disposed between first fixture output 66 and fixture input 62 at a first flow control point (71). Flow control point (71) is suitably positioned so that the first flow control valve 66v controls the flow of resource through first fixture output 66 without controlling the flow of resource second fixture output 64. For one alternative embodiment, a second flow control valve is disposed between said second fixture output 64 and said fixture input 66 at a second flow control point. Second flow control point is suitably positioned so that the second flow control valve controls the flow of resource through said second fixture output 64 without controlling the flow of resource through the first flow control output (66). As described above one or more flow control valves may be configured with a locking mechanism 68.

One of ordinary skill in the art will appreciate that the above teachings may be used to further include a main flow control valve disposed between said fixture input and all of the fixture outputs. For the embodiment depicted in FIG. 3, the flow control fixture comprises a fixture input, a fixture body, and fixture outputs that are substantially equal in size. For some embodiments, the size of the flow path through said fixture input and said fixture body are substantially equal but about 20% larger than the flow path through said plurality of fixture outputs. It should be appreciated that any suitable flow control fixture size configurations may be used without departing from the scope and spirit of the present invention.

As described above, the output solve flow control fixture (69) defines an adjustable connection that is adjustable to different types of connections including flared copper connections, compression connections, and iron pipe feting. Similarly, the fixture input of flow control fixture 69 preferably defines a meter coupling adaptable to a variety of meter sizes.

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. A residential utility meter for metering the flow of water through a residential water system, said utility meter comprising:
a fluid chamber defining a flow detection section disposed between an input and a plurality of outputs, said plurality of outputs comprising a first output and second output, said fluid chamber configured so that water flows into said input, through said flow detection section and then to said first output and said second output;
a first cutoff valve disposed between the first output and said flow detection section, wherein said first cutoff valve is configured with a first state that allows the flow of water through the first output and a second state which prevents the flow of water through the first output;
a second cutoff valve disposed between the second output and said flow detection section, wherein said second cutoff valve is configured with a first state that allows the flow of water through the second output and a second state which prevents the flow of water through the second output; and
wherein the water flow through the second output is not dependent on the state of the first cutoff valve and the water flow through the first output is not dependent on the state of the second cutoff valve.

2. A residential utility meter as in claim 1, wherein said utility meter is appropriately configured for being installed in a standard residential utility meter box.

3. A residential utility meter as in claim 1, wherein the first cutoff valve and the second cutoff valve are in horizontal alignment with each other and were in the first cutoff valve is disposed adjacent to the first output and the second cutoff valve is disposed adjacent to the second output.

4. A residential utility meter as in claim 1, wherein said first cutoff valve and said second cutoff valve are angle ball valves comprising a lockable valve key.

5. A residential utility meter as in claim 1, wherein the input, the first output, and the second output are in alignment with each other.

6. A residential utility meter enclosure configured for receiving a utility meter configured for metering resource consumption, said residential utility meter box comprising:
an enclosure defining at least a first wall opposed by a second wall wherein the first wall defines a service input and wherein the second wall defines a plurality of enclosure outputs;
an output-fixture defining a fixture-input and a plurality of fixture-outputs, wherein said fixture-outputs are associated with said plurality of enclosure outputs;
wherein said service input is suitably configured for being associated with the input of a utility meter and wherein the fixture-input is suitably configured for being associated with the output of a utility meter;
wherein said service input is in substantial horizontal alignment with said fixture-input;
wherein said plurality of fixture outputs includes a first output associated with a first flow control valve; and
wherein said first flow control valve is configured to control the flow of resources through said first output.

7. A residential utility meter enclosure as in claim 6, wherein said plurality of outputs further include a second output configured with a second flow control valve configured to control the flow of resource through said second output.

8. A residential utility meter enclosure as in claim 7, wherein said service input is in substantial vertical alignment with said fixture-input.

9. A residential utility meter enclosure as in claim 8, wherein said output fixture further comprises a main shutoff valve configured to control the flow of resource through all of said plurality of outputs.

10. A residential utility meter enclosure as in claim 9, wherein at least one control valve is configured with a locking mechanism.

11. A flow control fixture configured for controlling the flow of a resource, said flow control fixture comprising:
a fixture input suitably configured for being associated with the output of a utility meter;
a plurality of fixture outputs suitably configured for being associated with the resource supply lines of a residential resource supply system, said plurality of fixture outputs including a first fixture output and a second fixture output;
a fixture body disposed between said fixture input and said plurality of fixture outputs, said fixture body suitably configured for directing the flow of resource from said fixture input to said plurality of fixture outputs; and
a first flow control valve disposed between said first fixture output and said fixture input at a first flow control point suitably positioned so that said first flow control valve controls the flow of resource through said first fixture output without controlling the flow of resource through the second fixture output.

12. A flow control fixture as in claim 11, further comprising a second flow control valve disposed between said second fixture output and said fixture input at a second flow control point suitably positioned so that said second flow control valve controls the flow of resource through said second fixture output without controlling the flow of resource through said first fixture output.

13. A flow control fixture as in claim 12, further comprising a main flow control valve disposed between said fixture input and all of said plurality of fixture outputs at a main flow control point suitably positioned so that said main flow control valve controls the flow of resource through the flow control fixture.

14. A flow control fixture as in claim 11, further comprising a main flow control valve disposed between said fixture input and all of said plurality of fixture outputs.

15. A flow control fixture as in claim 11, where in a flow control valve is disposed between the fixture input and each of said plurality of fixture outputs.

16. A flow control fixture as in claim 15, wherein at least one flow control valve is configured with a locking mechanism.

17. A flow control fixture as in claim 11, wherein the size of the flow path through said fixture input and said fixture body are substantially equal and about 20% larger than the flow path through said plurality of fixture outputs.

18. A flow control fixture as in claim 12, wherein least one of said plurality of fixture outputs defines an adjustable connection that is adjustable to different types of connections including flared copper connections, compression connections, and iron pipe fitting connections.

19. A flow control fixture as in claim 12, wherein said fixture input defines a meter coupling adaptable to a variety of meter sizes.

20. A flow control fixture as in claim 12, wherein the flow path through said second output is twice the size of said flow path through said first fixture output.
